(19) United States
(12) Patent Application Publication
(10) Pub. No.: US 2018/0245482 A1
(43) Pub. Date: Aug. 30, 2018

(54) Turbocharger

(71) Applicant: MAN DIESEL & TURBO SE, Augsburg (DE)

(72) Inventors: Björn HOßBACH, Diedorf (DE); Santiago Uhlenbrock, Grafenberg (DE)

(21) Appl. No.: 15/905,509

(22) Filed: Feb. 26, 2018

(30) Foreign Application Priority Data
Feb. 27, 2017 (DE) 102017104001.3

(51) Int. Cl. F01D 25/24; F01D 25/16; F02C 6/12

(52) U.S. Cl. CPC F01D 25/243; F05D 2220/40; F02C 6/12; F01D 25/162

(57) ABSTRACT

A turbocharger, with a turbine for expanding a first medium and a compressor for compressing a second medium. The turbine has a turbine housing with a turbine inflow housing and a turbine rotor. The compressor has a compressor housing and a compressor rotor coupled to the turbine rotor via a shaft. The turbine housing and the compressor housing are connected to a bearing housing in which the shaft is mounted. The turbine inflow housing and the bearing housing are connected at flanges adjoining one another via fastening devices such that the flange of the turbine inflow housing, through which the fastening devices extend extends axially spaced as far as into the range of extent of the turbine rotor.

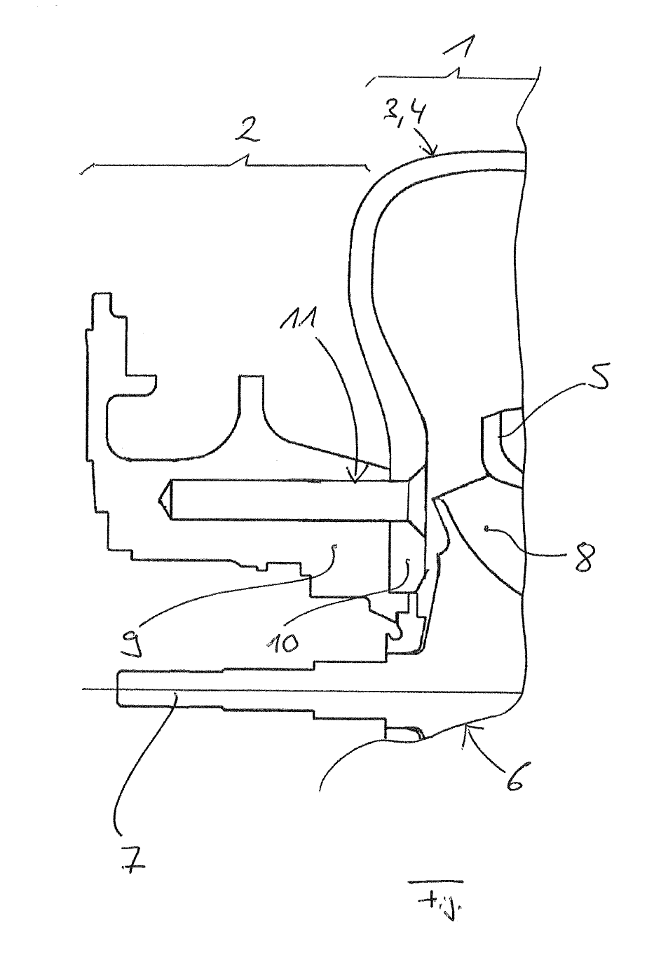

### BACKGROUND OF THE INVENTION

### 1. Field of the Invention

The invention relates to a turbocharger.

### 2. Description of the Related Art

A turbocharger comprises a turbine and a compressor. The turbine of the turbocharger expands a first medium, in particular for expanding exhaust gas, wherein during the expansion of the first medium energy is extracted. The compressor of the turbocharger compresses a second medium utilising the energy extracted during the expansion of the first medium. The turbine of the turbocharger comprises a turbine housing and a turbine rotor. The turbine housing comprises a turbine inflow housing and an inert piece. The compressor of the turbocharger comprises a compressor housing and a compressor rotor. The turbine rotor of the turbine and the compressor rotor of the compressor are coupled to one another via a shaft which is rotatably mounted in a bearing housing. The bearing housing is connected to the turbine housing and to the compressor housing.

In the case of turbochargers known from practice, the bearing housing is connected to the turbine inflow housing of the turbine housing via a clamping claw connection. The clamping claw connection comprises at least one clamping claw and one or more fastening screws. The clamping claw covers sections of bearing housing and turbine inflow housing adjoining one another and the fastening screw(s) extend through the clamping claw(s) in the relevant section of the turbine inflow housing and in the process clamp the turbine inflow housing and the bearing housing together. That section of the turbine inflow housing into which the fastening screws of the clamping claw connection extend is positioned, seen in the radial direction, radially outside a range of extent of the turbine rotor on a relatively large radius.

In turbochargers known from practice, the clamping claw connection is exposed to substantial loads. Accordingly, those sections of bearing housing and turbine inflow housing in the region of which the clamping claw connection is positioned, are exposed to different thermal loads as a result of which a relative movement between the components is brought about, which can result in a failure of the clamping claw connection.

### SUMMARY OF THE INVENTION

One aspect of the present invention is based on creating a new type of turbocharger. According to one aspect of the invention, the turbine inflow housing and the bearing housing are connected to one another via fastening devices at flanges adjoining one another in such a manner that the flange of the turbine inflow housing, through which the fastening devices extend, extends in the radial direction axially spaced as far as into the range of extent of the turbine rotor.

In the turbocharger according to one aspect of the invention, the connecting region between turbine inflow housing and bearing housing is moved compared with the turbochargers known from the prior art, to radially inside on a smaller radius or diameter namely in such a manner that the flange of the turbine inflow housing, through which fastening devices formed as fastening screws extend, extends seen in radial direction as far as into the range of extent of the turbine rotor, namely axially spaced from the turbine rotor. Because of this, stresses in the connected components are reduced. Furthermore, the sections in which the fastening devices are positioned are exposed to similar thermal loads. Altogether, the connection of turbine inflow housing and bearing housing can thereby be improved.

According to a further development of the invention, the turbine rotor, preferentially the moving blades of the same, cover the flange of the turbine inflow housing through which the fastening devices extend, and the fastening devices at least in sections. This is particularly preferred for a secure connection of turbine inflow housing and bearing housing. Undesirable stresses in the region of the components to be connected to one another and the fastening devices are kept as small as possible. This ensures a secure connection of turbine inflow housing and bearing housing.

Preferentially, the fastening devices extend, starting out from the flange of the turbine inflow housing, into the flange of the bearing housing. This makes possible easy assembling of turbine inflow housing and bearing housing.

Preferentially, the flange of the turbine inflow housing, through which the fastening devices extend, is arranged in axial direction seen from the turbine in the direction of the bearing housing behind the turbine rotor and in front of the flange of the bearing housing into which the fastening devices extend. These features also serve for the secure connection of turbine inflow housing and bearing housing minimising undesirable stresses in the assemblies to be connected to one another.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Exemplary embodiments of the invention are explained in more detail by way of the drawing without being restricted to this. There it shows:

The FIGURE is a cross section in the axial direction in the form of an extract through a turbocharger according to the invention in the region of a turbine and of a bearing housing.

### DETAILED DESCRIPTION OF THE PRESENTLY PREFERRED EMBODIMENTS

The invention relates to a turbocharger. A turbocharger comprises a turbine for expanding a first medium, in particular for expanding exhaust gas of an internal combustion engine. Furthermore, a turbocharger comprises a compressor for compressing a second medium, in particular charge air, namely utilising energy extracted in the turbine during the expansion of the first medium. Here, the turbine comprises a turbine housing and a turbine rotor. The compressor comprises a compressor housing and a compressor rotor. The compressor rotor is coupled to the turbine rotor via a shaft which is mounted in a bearing housing, wherein the bearing housing is positioned between the turbine housing and the compressor housing and connected both to the turbine housing and the compressor housing. The person skilled in the art addressed here is familiar with this fundamental construction of a turbocharger.

The FIGURE shows a schematic cross section in the form of an extract through a turbocharger in the region of a turbine 1 embodied as radial turbine and of a bearing housing 2. Of the turbine 1, a turbine housing 3 and a turbine rotor 6 are shown. The turbine housing 3 comprises at least one turbine inflow housing 4, via which medium to be expanded can be fed to the turbine rotor 6, and an insert piece 5, via which expanded medium can be discharged from the turbine rotor 6. The turbine rotor 6 carries moving blades 8.

The turbine rotor 6 is coupled to a compressor rotor of a compressor, which is not shown, via a shaft, wherein the shaft 7 is mounted in the bearing housing 2. The present invention now relates to details for connecting bearing housing 2 and turbine inflow housing 4, which ensures a secure connection of turbine inflow housing 4 and bearing housing 2 minimising or avoiding undesirable stresses in the components to be connected to one another.

As is evident from the FIGURE, the turbine inflow housing 4 and the bearing housing 2 are connected to one another at flanges 9, 10 adjoining one another via fastening devices 11, which are preferentially embodied as fastening screws. The flange 10 of the turbine inflow housing 4, through which the fastening devices 11 extend, extends seen in radial direction axially spaced from the turbine rotor 6 as far as into the radial range of extent of the turbine rotor 6 so that accordingly the fastening devices 11 compared with turbochargers known from practice are positioned on a relative small radius and thus diameter. Because of this, stresses in the components connected to one another are minimised. In the region of the fastening devices 11, turbine inflow housing 4 and bearing housing 2 are exposed approximately to same thermal loads. Undesirable relative movements between turbine inflow housing 4 and bearing housing 2 are minimised. Altogether, this reduces the risk of a failure of the connection between turbine inflow housing 4 and bearing housing 2.

In the projection, the turbine rotor 6 covers the flange 10 of the turbine inflow housing 4 through which the fastening devices 11 extend, at least in sections, in particular, the turbine rotor 6 covers the fastening devices 11 at least in sections. From the FIGURE it is evident that in the projection the moving blades 8 of the turbine rotor 6 cover or overlap at least in sections the fastening devices 11 and the flange 10 of the turbine inflow housing 4, through which the same extend. The above coverage is embodied seen in radial direction namely with axial spacing. Seen in the axial direction from the turbine 1 in the direction of the bearing housing 2, the flange 10 of the turbine inflow housing 4 through which the fastening devices 11 extend, is arranged behind the moving blades 8 of the turbine rotor 6 and in front of the flange 9 of the bearing housing 2, into which the fastening devices 11 extend.

The fastening devices 11, which are embodied as fastening screws, accordingly extend starting out from the flange 10 of the turbine inflow housing 4 into the flange 9 of the bearing housing 2. In the shown exemplary embodiment of a turbocharger according to one aspect of the invention, fastening devices 11, compared with fastening devices of clamping claw connections between turbine inflow housing and bearing housing known from practice, are rotated seen in the axial direction by approximately 180°.

With the invention, a particularly secure connection of the turbine inflow housing 4 of a turbine embodied preferentially as radial turbine and of the bearing housing 2 of a turbocharger can be provided.

In terms of this invention, radial turbines also refers to so-called mixed flow turbines, in which the gas flows in in the radial direction, but not only exactly perpendicularly to the shaft 7, but at an angle to the shaft 7.

Thermally induced stresses in the region of the connection between turbine inflow housing 4 and bearing housing 2 are reduced to a minimum, likewise undesirable relative movements between the assemblies to be connected to one another.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A turbocharger comprising:
a shaft;
a turbine configured to expand a first medium, comprising:
a turbine inflow housing;
a turbine inflow housing flange;
a turbine housing with the turbine inflow housing; and
a turbine rotor;
a compressor configured to compress a second medium utilising energy extracted in the turbine during the expansion of the first medium; the turbine, comprising:
a compressor housing; and
a compressor rotor coupled to the turbine rotor via the shaft; and
a bearing housing arranged between the turbine housing and the compressor housing and having a bearing housing flange and in which the shaft is mounted and to which the turbine housing and the compressor housing are connected;
wherein the turbine inflow housing and the bearing housing are connected to one another at their respective flanges adjoining one another via fastening devices such that the turbine inflow housing flange through which the fastening devices extend, extends seen in a radial direction axially spaced as far as into a range of extent of the turbine rotor.

2. The turbocharger according to claim 1, wherein the turbine rotor covers the turbine inflow housing flange through which the fastening devices extend at least in sections.

3. The turbocharger according to claim 2, wherein the turbine rotor covers the fastening devices at least in sections.

4. The turbocharger according to claim 3, wherein moving blades of the turbine rotor cover the fastening devices at least in sections.

5. The turbocharger according to claim 1, wherein the fastening devices starting out from the turbine inflow housing flange extend into the bearing housing flange.

6. The turbocharger according to claim 1, wherein in an axial direction seen from the turbine in a direction of the bearing housing the turbine inflow housing flange, through which the fastening devices extend, is arranged behind the turbine rotor and in front of the bearing housing flange, into which the fastening devices extend.

7. The turbocharger according to claim 1, wherein the turbine is a radial turbine.
